(19) United States
(12) Patent Application Publication
(10) Pub. No.: US 2015/0318999 A1
(43) Pub. Date: Nov. 5, 2015

(54) Derivation of a Device-Specific Value

(71) Applicants: Rainer Falk, Poing (DE); Andreas Mucha, Munchen (DE)

(72) Inventors: Rainer Falk, Poing (DE); Andreas Mucha, Munchen (DE)

(21) Appl. No.: 14/700,430

(22) Filed: Apr. 30, 2015

(30) Foreign Application Priority Data
Apr. 30, 2014 (DE) 102014208210.2

(51) Int. Cl. H04L 9/32; H04L 9/08

(52) U.S. Cl. CPC H04L 9/3278; H04L 9/0861

(57) ABSTRACT

A method and an apparatus for deriving a device-specific value from a physical unclonable function realized on a circuit unit are provided. Response values from a physical unclonable function (PUF) are categorized with respect to a statistical property, such as a bit error characteristic, and the device-specific value is derived therefrom.

This application claims the benefit of DE 10 2014 208 210.2, filed on Apr. 30, 2014, which is hereby incorporated by reference in its entirety.

### BACKGROUND

The present embodiments relate to derivation of a device-specific value from a physical unclonable function realized on a circuit unit.

Physical unclonable functions are known for the purpose of reliably identifying objects based on intrinsic physical properties. A physical property of an article (e.g., a semiconductor circuit) is used as an individual fingerprint in this context. By way of example, a physical unclonable function has a challenge applied to it and delivers a response that, when cloning the device, is meant to be ungeneratable when the same challenge is applied using the same physical unclonable function. A response is meant to be unpredictable and hence not able, even if the challenge is known, to be produced on another, cloned circuit. Hence, authentication may be achieved by the physical unclonable function (e.g., by virtue of a response or a value derived therefrom), such as a cryptographic key, being able to be generated only if there is access to the unaltered, unmanipulated circuit with the physical unclonable function implemented thereon.

Similarly, a physical unclonable function may be used to test whether a device or semiconductor circuit is an original product. In this case, too, a response is evaluated, for example, that may not be generated on a cloned or manipulated device or semiconductor circuit.

In the context of cryptographic security mechanisms, there is provision for the use of physical unclonable functions in order to avoid storing a cryptographic key in a memory or manually inputting the key. In order to prevent complex physically protected hardware chips or complex obfuscation of a key, physical unclonable functions are used. The production of a cryptographic key by applying a challenge to a physical unclonable function is a secure key memory.

In the context of the production of cryptographic keys and when using a physical unclonable function for checking identity or testing originality, a device-specific or hardware-specific identifier is to be provided in reproducible form.

The prior art involves physical unclonable functions or challenges that are applied to the physical unclonable function being tested in an initialization phase for suitability for use for key derivation or authenticity testing. In this context, it is, for example, generally known practice to use a static random access memory (SRAM) physical unclonable function (PUF), with an initial state of memory cells being used as a device-specific property. A check is first provided to determine which memory cells are stable. Only stable cells are used for the subsequent ascertainment of a key or identifier.

The use of physical unclonable functions for producing cryptographic keys involves the use of fuzzy key extractors, which use auxiliary data records to perform an error correction code method. Production of the auxiliary data is complex, and auxiliary data records that are produced are to be stored in suitable memory chips. This provides reproducible and secure generation of a cryptographic key. At the same time, the auxiliary data is to not contain a reference to the key, so that an error correction code is complex to produce.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, simplified derivation of a device-specific value using a physical unclonable function, without the need for an error correction code method, is provided.

A method according to one or more of the present embodiments for deriving a device-specific value from a physical unclonable function realized on a circuit unit involves the physical unclonable function having an identical challenge applied to the physical unclonable function at least twice in order to produce at least two responses. A categorization information item associated with the challenge is derived from a statistical property of the at least two responses, and the device-specific value is produced from the categorization information item.

The physical unclonable function (PUF) is used in the method without having previously checked the behavior of different responses in relation to different challenges or without having previously checked various configurations of the PUF. An arbitrary PUF that initially appears unsuitable for producing a reproducible response, or a PUF for which production of a reproducible device-specific value would require an error correction code method in the prior art, is also used based on the proposed method.

A physical unclonable function, a specific implementation of a physical unclonable function, or a stipulatable challenge that is applied to the physical unclonable function is thus characterized with respect to the statistical properties when a challenge is applied a plurality of times in succession. An identical realization of the physical unclonable function or an unaltered implementation or configuration of the physical unclonable function has an identical challenge applied to the physical unclonable function repeatedly. By way of example, the function has the identical challenge applied twice or eight times or several hundred times, and accordingly, two, eight or several hundred responses are ascertained.

The response behavior is generally unstable (e.g., response values vary among one another in characteristic form). The statistical deviations among the responses are characteristic of a realization or implementation or configuration of a physical unclonable function on a circuit unit in this case. The different ascertained responses are compared with one another, and a categorization information item is derived from the comparison.

The categorization information item therefore provides information about a relationship between the responses obtained from the identical challenge. It is not the value of a response as such, but rather a statistical value derived therefrom, such as the frequency of a bit pattern arising therein, that is used for the production of the device-specific value. A number of PUFs and also a number of challenges are thus available for performing the method. These may be used in known methods only with complex error correction code methods or not at all on account of nondeterministic behavior.

According to one embodiment, a bit error characteristic is ascertained from a series of responses as a categorization information item. Typically, bit errors arise for common physical unclonable functions when a challenge is used repeatedly to produce a response value. The different response values then differ from one another. This is referred to generally as a bit error.

In the prior art, suitable post-processing methods or error correction code methods may provide the suitability of the challenge or the configuration of the physical unclonable function (e.g., in order to produce an identical key on the original hardware or in order to produce an identifier for authenticity testing on an original circuit).

The mere detection of bit errors is used in the prior art to eliminate physical unclonable functions or the implementation or configuration thereof or a particular challenge value as unsuitable. The detection of bit errors is not used for deriving an identifier or a key.

The embodiment described involves the ascertainment of a bit error characterization being used for key generation or authenticity testing, for example. Analysis of the at least two responses allows an average or maximum number of different bits to be ascertained, for example. In this way, the responses are tested for stability for a particular challenge. In addition, a statistical variable that is dependent on the bit error distribution, such as a median value, a variance, standard deviation, a mean absolute deviation, a range (e.g., a difference between the largest and the smallest value), an inter quartile interval (e.g., a difference between the third quartile and the first quartile), an N-th central moment, a skewness or measure of asymmetry or an excess or measure of curvature, may be ascertained.

According to one embodiment, an association with one of at least two categories that may be stipulated by at least one threshold value is derived from the categorization information item, and the device-specific value is produced from the association with the category. By way of example, a threshold value that stipulates the number of bit errors or deviations from which a response falls into an “unstable” category is stipulated. Accordingly, the category “stable” is established up to the threshold value. Depending on association with one of the two categories, a bit value 0 or 1 is output. This forms the device-specific value. A device-specific value (e.g., a key bit) is derived from a challenge that is applied to the physical unclonable function repeatedly.

According to one embodiment, the device-specific value indicates the association with one of two categories as a binary value. This achieves a particularly simple realization that requires the stipulation of a threshold value.

According to one embodiment, the categorization information item is ascertained by comparing at least one response with a reference response, and the device-specific value is produced from the comparison. By way of example, the reference response is formed by the characteristic of a first ascertained response. In this case, the first response is ascertained when the associated first challenge is first applied, for example. In addition, it is similarly possible to ascertain a reference response as a reference bit error distribution, which is produced from averaging a plurality of responses that have been formed from the first challenge. Hence, the statistical property of a physical unclonable function or the implementation or configuration thereof is taken into account as early as when the reference response is produced.

The comparison of one or more responses with the reference response is ascertained, for example, by ascertaining a bit-by-bit difference and then averaging the bit-by-bit difference according to the number of responses, for example.

According to one embodiment, the device-specific value is used as an integrity identifier for a device. Hence, the authenticity of a device is checked by comparing a device-specific value or a series including a plurality of device-specific values with an original device-specific value produced in an initialization phase or with a series of device-specific values produced in an initialization phase. Copying a circuit on which the physical unclonable function is realized results in a deviation in the statistical behavior from response values that materialize in the deviation in the device-specific value. For example, when a series of device-specific values is produced, the presence of an unoriginal circuit may be identified if the deviation in an identifier provided from the device-specific values differs in too many places from a reference identifier. By way of example, a bit error characteristic ascertained as a categorization information item is compared with a reference bit error characteristic, and the identify or originality of the circuit is identified therefrom.

According to one embodiment, a key bit of a cryptographic key is formed from the device-specific value.

A suitable cryptographic key (e.g., for the purpose of decryption or for the purpose of formation of a signature by the circuit unit) may be produced only if an original, unmanipulated circuit with an unaltered physical unclonable function is present. At the same time, it is not necessary for stable responses to be able to be produced on the circuit with the physical unclonable function, since the statistical property may likewise be used as a physically characterizing feature. This advantageously allows the use of any physical unclonable functions.

According to one embodiment, a series of device-specific values is derived. The method according to one of the embodiments described above is carried out with respective further challenges for the purpose of producing respective further device-specific values, and the series is produced from the respective device-specific values. Depending on the desired length of the series, a number of challenges are to be provided. The respective computation to be performed uses just simple mathematical computation steps that do not give rise to complex implementation. For example, implementation may be effected in hardware and in software in a resource-saving manner. In this case, the respective challenge may also be repeated. By way of example, a series is used repeatedly in any order. In addition, an attack via side channels such as power consumption or electromagnetic radiation is made more difficult if a derived statistical property, such as that of stability, is used for producing the device-specific value.

According to one embodiment, a cryptographic key is formed from the series. Depending on the key length, the number of challenges used is of corresponding magnitude. Challenge series generators are suitable for repeatedly producing a plurality of series of challenge values. In this case, a required series of challenge values may be produced. Each challenge value is used repeatedly for application to the physical unclonable function.

In this case, repeated application of a challenge value from the challenge value series to the challenge response physical unclonable function may be effected in different ways. A response value may be determined in direct succession, or the series may be looped through repeatedly. The series may be looped through forward or backward, or a plurality of differently arrayed series may be produced. In addition, the series of challenge values may be determined randomly.

One or more of the present embodiments relate to an apparatus including a circuit unit. The circuit unit includes at least one physical unclonable function, for deriving at least one device-specific value. The apparatus includes a challenge generator for producing at least one challenge, the circuit unit for producing a response when the challenge is applied to the physical unclonable functions, and a response categorizer for deriving a categorization information item from a statistical property of the at least two responses. The apparatus also includes a derivation unit for deriving the device-specific value from a property of the categorization information item.

According to an embodiment, the apparatus also includes a key formation unit for producing a cryptographic key from a series of device-specific values, and a key memory for storing the cryptographic key.

### BRIEF DESCRIPTION OF THE DRAWINGS

FIG. 1 shows a schematic illustration of an apparatus and a method for deriving a device-specific value according to a first exemplary embodiment; and

FIG. 2 shows a schematic illustration of parts of an apparatus and a section of a method for storing a cryptographic key according to a second exemplary embodiment.

### DETAILED DESCRIPTION

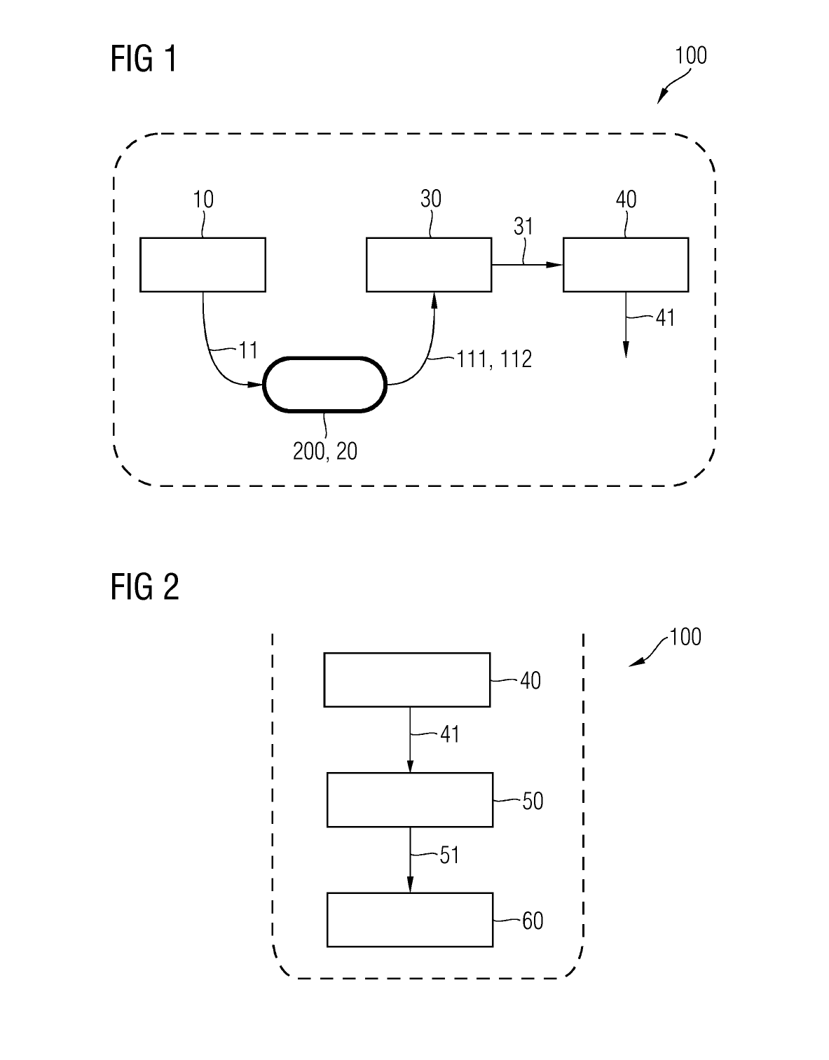

FIG. 1 schematically shows one embodiment of an apparatus 100 with a circuit unit 200 situated thereon. In this arrangement, the circuit unit 200 may be part of the apparatus 100. The apparatus 100 may have a plurality of circuit units, for example. The apparatus 100 is, for example, an embedded system. The circuit unit 200 has a physical unclonable function (PUF) 20 implemented on the circuit unit 200. This is a challenge/response PUF that delivers a response to a challenge or a request value. By way of example, the challenge/response PUF may be a ring oscillator PUF, a bistable ring PUF, a delay PUF, an arbiter PUF, or a butterfly PUF.

By way of example, the challenge has a value range of 8 bits and is produced by a challenge generator 10. In this case, the challenge generator is capable of producing an identical challenge repeatedly and of producing a series of challenges. By way of example, each bit pattern of the 8-bit challenge may be generated (e.g., the 256 values from 00000000 to 11111111). Each challenge in the challenge series may be produced repeatedly. The response value that is produced when the PUF is queried with the challenge has a magnitude of 32 bits. By way of example, eight responses are ascertained and stored in a table for the associated challenge.

For each challenge value, the response categorizer 30, which is part of the apparatus 100, computes an averaged difference for the Hamming weights of the ascertained responses. This is done based on the following formula, for example:

MDHW= 1/7*Σ_{i=1 . . . 7}HW(R₀XORRᵢ)

In this case, R0 represents the first ascertained response and is used as a reference value. For every further subsequent response R1 to R7, the Hamming weight HW is ascertained for the reference value R0 and summed. This is divided by seven on account of the seven summands.

Alternatively, the Hamming weight of the difference may also be determined in pairs for all different responses Ri, Rj and summed. This may be carried out based on the following formula:

MDHW= 1/28*Σ_{i=0 . . . 6}Σ_{j=(i+1) . . . 7}HW(RᵢXORRⱼ)

The Hamming weights of the respective combinations of responses Ri, Rj are added with different indices in order to cover all combinations. Since there are n*(n−1)/2 combinations (e.g., 28 different combinations in this case), division is by 28.

The averaged difference in the Hamming weights forms a categorization information item 31. The categorization information item 31 is compared with a threshold value using a derivation unit 40. In the case of a 32-bit response, no more than 32 bits may be different. In the present exemplary embodiment, challenge values are categorized as stable if the associated averaged difference in the Hamming weights is less than the threshold value. By way of example, the threshold value stipulated is the value 8. Categorization as stable (e.g., a categorization information item 31 that is less than the threshold value 8) results in a key bit with the value 0 as device-specific value 41. Otherwise, the derivation unit 40 determines a key bit with the value 1 as device-specific value 41.

In a similar manner to the approach for the first challenge from the challenge series, the respective device-specific value is also produced for all further challenges in the challenge series.

FIG. 2 shows further features of an apparatus 100 that is suitable for storing a cryptographic key 51 according to a second exemplary embodiment. Besides a derivation unit 40 for deriving a device-specific value 41 that is in the form of a key bit, the apparatus also has a key formation unit 50 for producing a cryptographic key 51. The key formation unit 50 produces the cryptographic key 51, which is used in cryptographic methods, for a series of device-specific values that has been produced from a series of challenges. The cryptographic key 51 is stored in a key memory 60 of the apparatus. For the purpose of providing a cryptographic key 51 on an embedded device, a secure method and a secure apparatus are therefore provided that may be realized simultaneously with little hardware complexity. In this case, the cryptographic key 51 is produced by a PUF that, despite an unstable behavior for response production, does not require auxiliary data records or helper data and is suitable for reliable key formation on the circuit unit. This provides that no complex initialization phase in which the auxiliary data records are produced is necessary.

The key formation unit 50 performs concatenation of the device-specific values produced for each challenge that form the individual key bits. A cryptographic key 51 with a length of 256 bits may thus be produced, for example.

The key memory 60 may be a volatile memory that loses memory content without a supply of power. By way of example, the key memory 60 is a register including D-type flipflops or an SRAM memory.

Depending on the required entropy per key bit, post-processing methods that are additionally used for producing the cryptographic key 51 may be used.

The units of the apparatus 100 that have been described may be realized on the circuit unit 200 together, depending on application.

The challenge generator, response categorizer, derivation unit, key formation unit and key memory may be implemented in hardware and/or also in software. In the case of a hardware implementation, the respective unit may be in the form of an apparatus or in the form of part of the apparatus 100 (e.g., in the form of a computer or in the form of a microprocessor). For example, the apparatus 100 may be an embedded system. In the case of a software implementation, the respective unit may be in the form of a computer program product, in the form of a function, in the form of a routine, in the form of part of a program code, or in the form of an executable object.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for deriving a device-specific value from a physical unclonable function realized on a circuit unit, the method comprising:
applying an identical challenge to the physical unclonable function of the circuit unit at least twice in order to produce at least two responses;
deriving, by a processor, a categorization information item associated with the identical challenge from a statistical property of the at least two responses; and
producing the device-specific value from the categorization information item.

2. The method of claim 1, further comprising ascertaining a bit error characteristic from a series of responses as a categorization information item.

3. The method of claim 2, further comprising:
deriving an association with one of at least two categories that are derivable by at least one threshold value from the categorization information item; and
producing the device-specific value from the association with the one category.

4. The method of claim 3, wherein the device-specific value indicates the association with the one category as a binary value.

5. The method of claim 1, wherein the categorization information item is ascertained by comparing at least one response of the at least two responses with a reference response, and the device-specific value is produced therefrom.

6. The method of claim 1, wherein the device-specific value is used as an integrity identifier for a device.

7. The method of claim 1, further comprising forming a key bit of a cryptographic key from the device-specific value.

8. A method for deriving a series of device-specific values, the method comprising:
deriving device-specific values with a plurality of challenges from a physical unclonable function realized on a circuit unit, the deriving for each challenge of the plurality of challenges comprising:
applying the challenge to the physical unclonable function at least twice in order to produce at least two responses;
deriving, by a processor, a categorization information item associated with the challenge from a statistical property of the at least two responses; and
producing the device-specific value from the categorization information item; and
producing the series of device-specific values from the respective device-specific values.

9. The method of claim 8, wherein a cryptographic key is formed from the series of device-specific values.

10. The method of claim 8, wherein the deriving for each challenge of the plurality of challenges further comprises ascertaining a bit error characteristic from a series of responses as a categorization information item.

11. The method of claim 10, wherein the deriving for each challenge of the plurality of challenges further comprises:
deriving an association with one of at least two categories that are derivable by at least one threshold value from the categorization information item; and
producing the device-specific value from the association with the one category.

12. The method of claim 11, wherein the device-specific value indicates the association with the one category as a binary value.

13. The method of claim 8, wherein the categorization information item is ascertained by comparing at least one response of the at least two responses with a reference response, and the device-specific value is produced therefrom.

14. The method of claim 8, wherein the device-specific value is used as an integrity identifier for a device.

15. The method of claim 8, wherein the deriving for each challenge of the plurality of challenges further comprises forming a key bit of a cryptographic key from the device-specific value.

16. An apparatus comprising:
a challenge generator configured to produce at least one challenge;
a circuit unit comprising at least one physical unclonable function for deriving at least one device-specific value, the circuit unit being configured to produce at least two responses when the at least one physical unclonable function has an identical challenge of the at least one challenge applied to the at least one physical unclonable function at least twice;
a response categorizer configured to derive a categorization information item from a statistical property of the at least two responses; and
a derivation unit configured to derive the device-specific value from the categorization information item.

17. The apparatus of claim 16, further comprising:
a key formation unit configured to produce a cryptographic key from a series of device-specific values produced based on the derived device-specific value;
a key memory configured to store the cryptographic key.
